(19) United States
(12) Patent Application Publication
(10) Pub. No.: US 2023/0289554 A1
(43) Pub. Date: Sep. 14, 2023

(54) SMART CARD MODULE, SMART CARD MODULE ARRANGEMENT AND SMART CARD

(71) Applicant: Infineon Technologies AG, Neubiberg (DE)

(72) Inventors: Jens Pohl, Bernhardswald (DE); Frank Püschner, Kelheim (DE); Thomas Spöttl, Mintraching (DE); Peter Stampka, Burglengenfeld (DE)

(21) Appl. No.: 18/182,468

(22) Filed: Mar. 13, 2023

(30) Foreign Application Priority Data
Mar. 14, 2022 (DE) 102022105821.2

(51) Int. Cl. G06K 19/077

(52) U.S. Cl. CPC G06K 19/07747

(57) ABSTRACT

A smart card module including a contact region with at least one electrical smart card module contact, and a verification code display unit configured to display a verification code, the verification code display unit being arranged in the smart card module, wherein the verification code display unit is configured as a dynamic permanent display unit, the controlled display of which continues to be displayed after deenergization of the verification code display unit.

### TECHNICAL FIELD

The disclosure relates to a smart card module, a smart card module arrangement and a smart card.

### BACKGROUND

Conventional standard smart cards, for example credit cards, are provided with a security code printed thereon (usually on the rear side). The security code is also referred to as Card Validation Code (CVC), Card Verification Value (CVV), Card Verification Number (CVN), Card Security Code (CSC), Card Code Verification (CCV), Card Check Number (CCN) or verification code.

The fact that the verification code is printed on and is thus static has the disadvantage that third parties can obtain knowledge of the verification code therefrom (for example simultaneously with the card number) and can thereupon use the verification code for fraudulent activities, for example for unauthorized shopping on the Internet.

For this reason, credit card providers would like to replace the static verification code with a dynamic verification code which is displayed in a display integrated in the credit card (typically an electronic ink display).

A display of the integrated display is typically permanently visible, even when the energy supply is switched off.

In various exemplary aspects, a credit card having an increased security level is provided in an efficient manner.

In various exemplary aspects, as a contact-based credit card, the credit card can be concomitantly equipped with a contact region and a dynamic verification code display unit for dynamically providing the verification code.

For efficiently providing the credit card, in various exemplary aspects, a smart card module can be provided in which the contact region and the verification code display unit are integrated.

In addition, a biometric sensor (also referred to as a biometry sensor), for example a fingerprint sensor, can be integrated in the smart card module.

By means of a single integration process (introducing the smart card module into the smart card body), the smart card can thus be equipped with the possibility of dynamically providing the verification code and with at least one further function.

In various exemplary aspects, the verification code display unit can be arranged on a rear side of the biometric sensor or between the biometric sensor and the contact region.

In various exemplary aspects, a security element can be provided which can be configured to control the contact region and/or the biometric sensor in addition to the dynamic providing of the verification code by means of the display unit.

In various exemplary aspects, a smart card module arrangement can comprise a dynamic verification code display unit and a biometric sensor, which are optionally provided as separate devices, which are only electrically conductively connected or inductively or capacitively coupled.

This can make it possible, for example, to arrange the display at a position remote from the biometric sensor (and, if appropriate, from an optionally contained contact region), which simplifies simultaneous use of display, sensor and, if appropriate, contact region.

### BRIEF DESCRIPTION OF THE DRAWINGS

Exemplary aspects of the disclosure are illustrated in the figures and are explained in greater detail below.

In the Figures:

FIG. 1 and FIG. 2 each show a schematic illustration of a method for forming a smart card module in accordance with various exemplary aspects;

FIG. 3 shows a schematic perspective illustration of a dynamic verification code display unit that is used in a smart card module in accordance with various exemplary aspects; and

FIG. 4 and FIG. 5 each show a schematic illustration of a method for forming a smart card in accordance with various exemplary aspects.

### DETAILED DESCRIPTION

In the following detailed description, reference is made to the accompanying drawings, which form part of this description and show for illustration purposes specific aspects in which the subject matter of the disclosure can be implemented. In this regard, direction terminology such as, for instance, “at the top”, “at the bottom”, “at the front”, “at the back”, “front”, “rear”, etc. is used with respect to the orientation of the figure(s) described. Since components of aspects can be positioned in a number of different orientations, the direction terminology serves for illustration and is not restrictive in any way whatsoever. It goes without saying that other aspects can be used and structural or logical changes can be made, without departing from the scope of protection of the present disclosed subject matter. It goes without saying that the features of the various exemplary aspects described herein can be combined with one another, unless specifically indicated otherwise. Therefore, the following detailed description should not be interpreted in a restrictive sense, and the scope of protection of the present disclosed subject matter is defined by the appended claims.

In the context of this description, the terms “connected”, “attached” and “coupled” are used to describe both a direct and an indirect connection, a direct or indirect attachment and a direct or indirect coupling. In the figures, identical or similar elements are provided with identical reference signs, insofar as this is expedient.

The production of a smart card module in accordance with various exemplary aspects (e.g. the smart card module having a biometric sensor and/or having a contact region) is typically implemented as a roll-to-roll method using a 35 mm tape that is typical for smart card modules. For the sake of simplicity, only a single smart card module without the tape is illustrated here in each case.

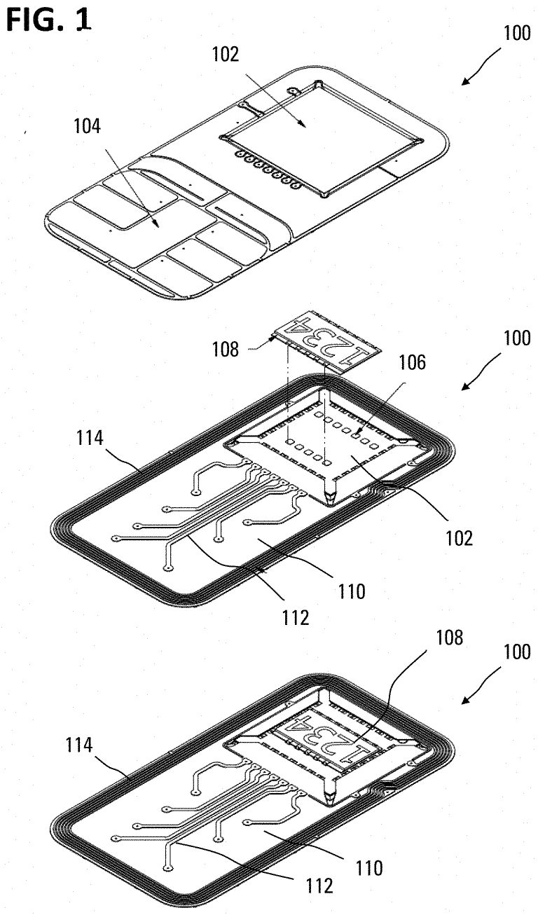

FIG. 1 is a schematic illustration of a method for forming a smart card module 100 in accordance with various exemplary aspects.

The smart card module 100 comprises a contact region 104 with at least one electrical smart card module contact. The contact region 104 can be configured to provide contact-based communication with an external reader, for example if the smart card module is integrated in a smart card. The contact region 104 can be configured for example in a manner conforming to ISO 7816.

The smart card module 100 can furthermore comprise a verification code display unit 108 (for short: display unit or display) for displaying a verification code, wherein the verification code display unit 108 is configured as a dynamic permanent display unit, the controlled display of which continues to be displayed after deenergization of the verification code display unit 108.

The dynamic permanent display unit can be configured, during a use duration, i.e. during use on the part of the user, to change the verification code at least once, for example in a time- or event-controlled manner.

Time-controlled can mean, for example, that the display is changed regularly, for example once per hour, once a day, or with any other arbitrary regularity deemed to be expedient. In that case, the smart card module 100 can comprise a timer that provides a real time in order to be able to match the provided verification code to a centrally stored reference verification code with accurate timing.

In that case, the smart card module can comprise an energy store at least for changing the display and for operating the timer.

Event-controlled can mean, for example, that the verification code is changed upon or after an occurrence of a defined event, for example after each transaction in which the verification code was interrogated, and/or upon each communication with a smart card reader, or the like.

In the last-mentioned case, an energy store can possibly be dispensed with since the required energy is provided during the communication (contact-based or contactless if the smart card module is a dual interface module) and electronic ink maintains its information typically for weeks or even months without energy being fed in.

Electronically controlled changeable displays which maintain their display (and thus the state of their display elements) even after the current has been turned off are typically referred to as electronic ink or e-ink or else as electronic paper. By way of example, each of the display elements can be able to be brought to one of two bistable states having different colors by means of electrophoresis.

Providing the display unit 108 as part of the smart card module 100, i.e. together with the contact region 104, which is provided anyway as part of a smart card module 100 for integration into a card body (and, if appropriate, additionally has a functionality of a biometric sensor), simplifies the process of integrating the display unit 108 in the card body.

This is because in the simplest case the card manufacturer needs only to insert the smart card module 100 into the smart card body, without having to provide additional connecting elements (such as, for example, printed circuit boards (PCBs) in the card body). That means a huge cost saving for the card manufacturer and also an increased robustness and reliability of the card.

In the simplest case mentioned, the smart card module 100 can be designed as a so-called Coil on Module® module, configured for implementing an energy supply and a signal transmission by means of an antenna 114 on the smart card module 100, said antenna being inductively coupled to a booster antenna in the smart card body.

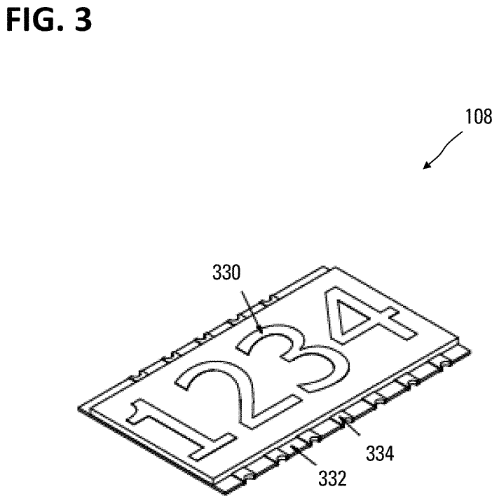

FIG. 3 shows a verification code display unit 108 that can be or have been integrated in a smart card module 100 in accordance with various exemplary aspects.

The verification code display unit 108 can comprise a substrate 332, for example a PCB substrate, which can comprise terminals 334 for an energy supply and a signal transmission, for example for controlling the display unit. The terminals 334 can be connected to corresponding chip contacts on a chip of the chip module (which chip can be formed e.g. as a security element).

The verification code display unit 108 can furthermore comprise a display surface 330, on which or by which the verification code is displayable or is displayed.

Instead of the terminals 334, the verification code display unit 108 can be configured for inductive or capacitive control, i.e. without galvanic connections. For this purpose, the verification code display unit 108 can be equipped with a (dedicated) coupling antenna.

In various exemplary aspects, the contact region 104 can be exposed at a first side of the smart card module 100, which side is also referred to as the top side of the smart card module 100. In FIG. 1 that is for example the top side of the upper illustration. In the middle and lower illustrations, the smart card module 100 is illustrated in each case with its underside (also referred to as rear side or as second side) facing upward, said underside being situated opposite the top side.

In the exemplary aspect from FIG. 1, a display of the verification code display unit 108 at the rear side is exposed or is covered by transparent material.

Accordingly, the contact region 104 and the verification code display unit 108 can have their functional surfaces on opposite sides of the smart card module 100, i.e. can be contactable (the contact region 104) and respectively visible (the display unit 108) from opposite sides.

In the exemplary aspect from FIG. 1, the smart card module 100 furthermore comprises the biometric sensor 102. The biometric sensor 102 is arranged in an opening of a module substrate 110.

The module substrate 110 can be formed from the abovementioned carrier tape or, for example, from a material identical or similar to that of known carrier tape materials (e.g. a polymer).

A bottom of the opening can be partly open, such that the rear side of the biometric sensor 102 introduced into the opening can be at least partly exposed.

This makes it possible, after the biometric sensor 102 has been arranged, for the verification code display unit 108 to be fitted to the rear side of the biometric sensor 102, for example to contact points 106 arranged on the biometric sensor 102.

The verification code display unit 108 can be connected to the contact points 106 in an essentially known manner, for example by means of soldering, anisotropic conductive adhesive (ACA), conductive adhesive, etc.

In one exemplary aspect that is not illustrated, the verification code display unit 108 can firstly be or have been fitted to the rear side of the biometric sensor 102, and the biometric sensor 102 can subsequently be introduced into the opening of the module substrate 110. The module substrate 110 can in turn have been provided with a through opening, through which the verification code display unit 108 is visible, or the module substrate 110 can be transparent at least in the region in which it extends over the display surface 330.

In other exemplary aspects that are not illustrated, the verification code display unit 108 can be fitted to a different point of the rear side of the smart card module 100, for example on or in the module substrate 110. Corresponding connection lines can be formed for example simultaneously with connection lines 112 for the smart card module contacts of the contact region, and/or connection lines of used and/or unused smart card module contacts can be used for the operation of the verification code display unit 108.

The connections required on the verification code display unit 108 can comprise for example standard contacts of the smart card module contacts of the contact regions 112 (i.e. for contact-based communication), for example positive and negative supply voltage (V_{cc} and Vₛₛ respectively), reset RST, a time signal CLK, and/or data input/output. If necessary, additional signals (and, if appropriate, corresponding connections) for operating the verification code display unit 108 can be or have been provided.

In various exemplary aspects, the contact region 104 can be exposed at a first side of the smart card module 100, and the display of the verification code display unit 108 can likewise be exposed at the first side or be covered by transparent material.

Accordingly, the contact region 104 and the verification code display unit 108 can have their functional surfaces on the same side of the smart card module 100, i.e. can be contactable (the contact region 104) and respectively visible (the display unit 108) from the same side.

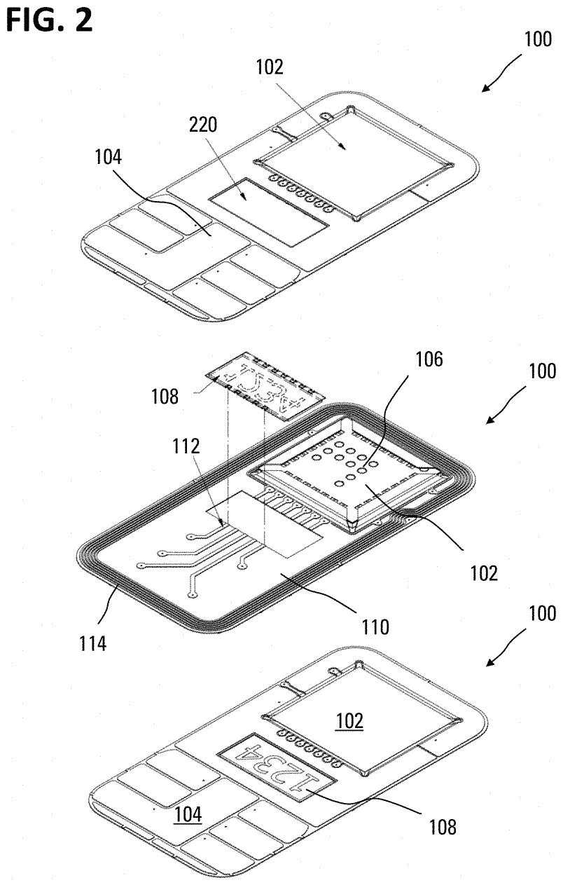

A corresponding exemplary aspect is illustrated in FIG. 2.

For the purpose of introducing the verification code display unit 108 into the front side of the smart card module 100, the module substrate 110 can have been provided with an opening 220.

The verification code display unit 108 can be or have been arranged in the opening 220 such that its display surface 330 faces the front side.

FIG. 2 illustrates that the verification code display unit 108 is introduced into the opening 220 from a rear side. Provided that the opening 220 is a through opening, the verification code display unit 108 can alternatively be introduced into the opening 220 from the front side. The verification code display unit 108 can be arranged such that its display surface 330 terminates coplanar with the contact surfaces of the contact region 104 in order not to project beyond the card surface after installation in a smart card body.

The connection lines 112 or additional connection lines formed together with the connection lines can be used for connecting the verification code display unit 108.

The verification code display unit 108 can be connected to the connection lines 112 in an essentially known manner, for example by means of soldering, anisotropic conductive adhesive (ACA), conductive adhesive, etc.

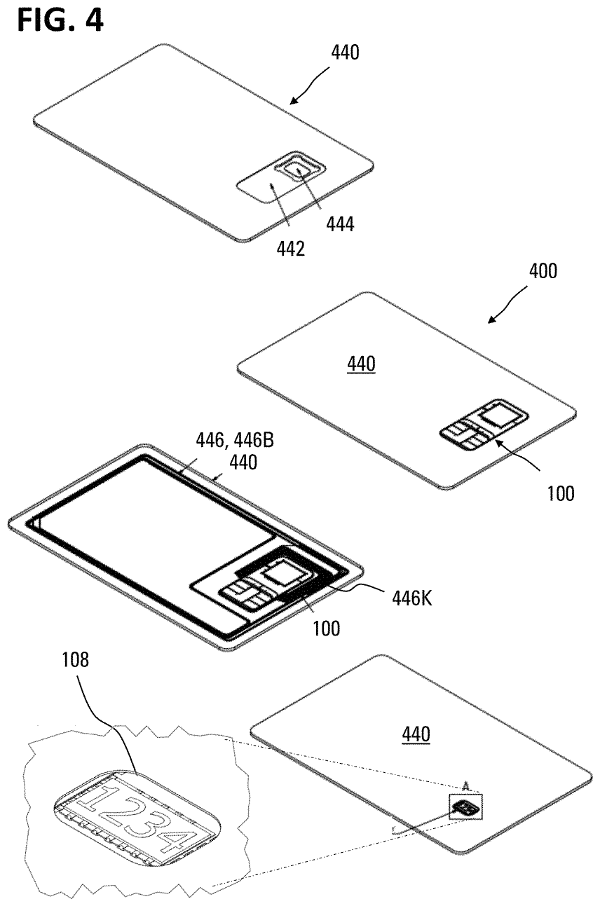

In various exemplary aspects, a smart card 400 is provided. A corresponding exemplary aspect is illustrated in FIG. 4.

The smart card 400 comprises a smart card body 440 having an opening 442, 444 and a smart card module 100 in accordance with any of the exemplary aspects described above arranged in the opening 442, 444.

In the exemplary aspect in FIG. 4, the verification code display unit 108, as illustrated in FIG. 1, is arranged on the rear side of the biometric sensor 102. In order to accommodate the verification code display unit 108, therefore, the additional depression 444 extending in a manner proceeding from the opening 442 further into the module body 110 is provided as part of the opening 442, 444.

The smart card module 100 can be introduced into the smart card body 440 in an essentially known manner, which constitutes one of the advantages of the present aspects.

In a case where the verification code display unit 108 is arranged with a display surface 330 facing the rear side of the smart card module 100, the smart card body 440 can be removed or be exposed over the verification code display unit 108. To put it another way, the smart card body 440 can be designed such that, with the smart card module 100 accommodated in the smart card body 440, the display surface 330 is exposed or is covered (e.g. exclusively) by transparent material.

FIG. 4 illustratively shows the smart card as viewed from the rear side in the bottommost illustration, together with a detail-enlarged illustration of the verification code display unit 108.

In such a case, care should be taken to ensure that, for example, an adhesive for securing the smart card module 100 in the smart card body 440 is applied in such a way that the adhesive does not advance into a region over the display surface 330.

If the display surface 330 is still covered by a transparent layer of the smart card body 440, a transparent adhesive can completely fill the gap between the bottom of the opening 444 in the smart card body and the display surface 330 and thus secure the verification code display unit 108 to the bottom of the smart card body 440.

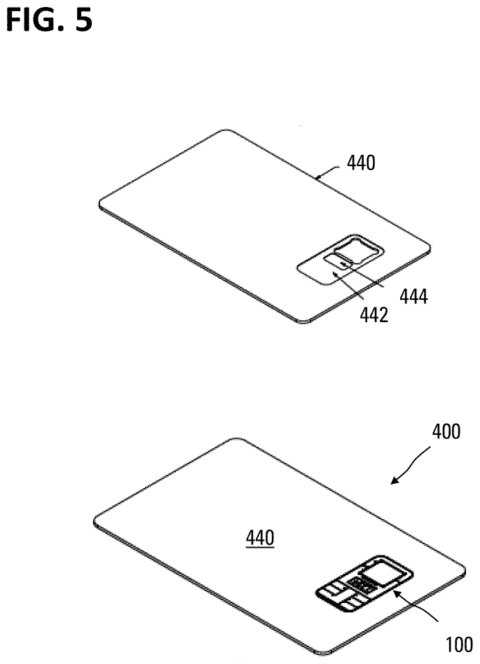

FIG. 5 schematically illustrates a method for forming a smart card 400 in accordance with various exemplary aspects and shows the result.

The smart card 400 is similar to the smart card 400 from FIG. 4, apart from the differences explained below.

In the case of the smart card 400 from FIG. 5, a smart card module 100, which is similar or identical to the smart card module 100 from FIG. 2, is introduced into the opening 442, 444 of the smart card body 440.

The verification code display unit 108 may possibly protrude at a rear side of the smart card module 100, and so the additional depression 444 is provided for accommodating the verification code display unit 108, in a manner similar to that in the case of the smart card 400 in FIG. 4.

However, the display surface 330 faces the front side of the smart card module 100, and thus also the front side of the smart card 400. Accordingly, the smart card body 440 need not be provided with a through opening or a transparent rear side.

In various exemplary aspects, provision can be made (not illustrated) of a smart card module arrangement comprising a sensor module having a fingerprint sensor, and a verification code display unit for displaying a verification code.

In this case, the verification code display unit can be electrically connected to the biometric module and can be configured as a dynamic permanent display unit, the controlled display of which continues to be displayed after deenergization of the verification code display unit, and wherein the sensor module is configured to control the verification code display unit for the purpose of displaying the verification code.

Such a design of the verification code display unit makes it possible, in particular, to provide only a single chip in the smart card, for example a secure element, which is used for controlling the sensor module, but affords the possibility of arranging the verification code display unit at a distance from the sensor module (only galvanically, inductively or capacitively coupled).

A smart card which enables a relatively free relative positioning of the smart card module and the verification code display unit can thus be provided in a simple and cost-effective manner.

Some exemplary aspects are specified in summary below.

Exemplary aspect 1 is a smart card module which comprises a contact region with at least one electrical smart card module contact, and a verification code display unit for displaying a verification code, said verification code display unit being arranged in the smart card module, wherein the verification code display unit is configured as a dynamic permanent display unit, the controlled display of which continues to be displayed after deenergization of the verification code display unit.

Exemplary aspect 2 is a smart card module in accordance with exemplary aspect 1, wherein the contact region is exposed at a first side of the smart card module, and wherein a display of the verification code display unit is likewise exposed at the first side or is covered by transparent material.

Exemplary aspect 3 is a smart card module in accordance with exemplary aspect 2, wherein the verification code display unit is arranged adjacent to the contact region.

Exemplary aspect 4 is a smart card module in accordance with exemplary aspect 1, wherein the contact region is exposed at a first side of the smart card module, and wherein a display of the verification code display unit is exposed at a second side, situated opposite the first side, or is covered by transparent material.

Exemplary aspect 5 is a smart card module in accordance with any of exemplary aspects 1 to 4, which furthermore comprises a biometry sensor module having a sensor surface, which is exposed on the same side of the smart card module as the contact region.

Exemplary aspect 6 is a smart card module in accordance with exemplary aspect 5, wherein the verification code display unit is arranged between the biometry sensor module and the contact region.

Exemplary aspect 7 is a smart card module in accordance with exemplary aspect 5, which furthermore comprises a biometry sensor module, wherein the verification code display unit is arranged on a rear side of the biometry sensor module.

Exemplary aspect 8 is a smart card module in accordance with exemplary aspect 5, which furthermore comprises a biometry sensor module, wherein the verification code display unit is fitted directly to the biometry sensor module.

Exemplary aspect 9 is a smart card module in accordance with any of exemplary aspects 1 to 8, wherein the verification code display unit is configured as an electronic ink display comprising a plurality of display elements, wherein each of the display elements is able to be brought to one of two bistable states having different colors by means of electrophoresis.

Exemplary aspect 10 is a smart card module in accordance with any of exemplary aspects 1 to 9, wherein the contact region is configured as an ISO-7816 contact region.

Exemplary aspect 11 is a smart card module in accordance with any of exemplary aspects 1 to 9, which furthermore comprises a security element configured for controlling the contact region and the verification code display unit.

Exemplary aspect 12 is a smart card module in accordance with exemplary aspect 11, which furthermore comprises a biometry sensor module, wherein the security element is part of the biometry sensor module and is furthermore configured for controlling the biometry sensor module.

Exemplary aspect 13 is a smart card module in accordance with any of exemplary aspects 1 to 12, which furthermore comprises an antenna configured for contactless communication.

Exemplary aspect 14 is a smart card which comprises a smart card body having an opening, and a smart card module in accordance with any of exemplary aspects 1 to 13 arranged in the opening.

Exemplary aspect 15 is a smart card in accordance with exemplary aspect 14, wherein the smart card body is transparent or open over the verification code display unit.

Exemplary aspect 16 is a smart card module arrangement which comprises a sensor module having a fingerprint sensor, and a verification code display unit for displaying a verification code, wherein the verification code display unit is electrically connected to the biometric module and is configured as a dynamic permanent display unit, the controlled display of which continues to be displayed after deenergization of the verification code display unit, and wherein the sensor module is configured to control the verification code display unit for the purpose of displaying the verification code.

Exemplary aspect 17 is a smart card module arrangement in accordance with exemplary aspect 16, wherein the sensor module comprises a security element, and wherein the security element is configured to control the verification code display unit for the purpose of displaying the verification code.

Exemplary aspect 18 is a smart card module arrangement in accordance with exemplary aspect 16 or 17, wherein the sensor module and the verification code display unit are arranged separately from one another and are electrically conductively connected or inductively or capacitively coupled.

Exemplary aspect 19 is a smart card comprising a smart card body, and a smart card module arrangement in accordance with any of exemplary aspects 1 to 13.

Exemplary aspect 20 is a smart card in accordance with exemplary aspect 19, wherein the smart card body is transparent or open over the verification code display unit.

Further advantageous aspects of the device are evident from the description of the method, and vice versa.

1. A smart card module, comprising:
a contact region with at least one electrical smart card module contact; and
a verification code display unit configured to display a verification code, the verification code display unit being arranged in the smart card module, wherein the verification code display unit is operable as a dynamic permanent display unit, the display of which continues to be displayed after deenergization of the verification code display unit.

2. The smart card module as claimed in claim 1,
wherein the contact region is exposed at a first side of the smart card module, and
wherein a display of the verification code display unit is exposed at the first side or is covered by transparent material.

3. The smart card module as claimed in claim 2,
wherein the verification code display unit is arranged adjacent to the contact region.

4. The smart card module as claimed in claim 1,
wherein the contact region is exposed at a first side of the smart card module, and
wherein a display of the verification code display unit is exposed at a second side, situated opposite the first side, or is covered by transparent material.

5. The smart card module as claimed in claim 1, further comprising:
a biometry sensor module having a sensor surface, which is exposed on the same side of the smart card module as the contact region.

6. The smart card module as claimed in claim 5,
wherein the verification code display unit is arranged between the biometry sensor module and the contact region.

7. The smart card module as claimed in claim 5, further comprising:
a biometry sensor module,
wherein the verification code display unit is arranged on a rear side of the biometry sensor module.

8. The smart card module as claimed in claim 5, further comprising:
a biometry sensor module,
wherein the verification code display unit is fitted directly to the biometry sensor module.

9. The smart card module as claimed in claim 1,
wherein the verification code display unit is configured as an electronic ink display having a plurality of display elements, wherein each of the display elements is settable to one of two bistable states having different colors by means of electrophoresis.

10. The smart card module as claimed in claim 1,
wherein the contact region is configured as an ISO-7816 contact region.

11. The smart card module as claimed in claim 1, further comprising:
a security element configured to control the contact region and the verification code display unit.

12. The smart card module as claimed in claim 11, further comprising:
a biometry sensor module,
wherein the security element is part of the biometry sensor module and is further configured to control the biometry sensor module.

13. The smart card module as claimed in claim 1, further comprising:
an antenna configured for contactless communication.

14. A smart card, comprising:
a smart card body having an opening; and
a smart card module as claimed in claim 1, arranged in the opening.

15. The smart card as claimed in claim 14,
wherein the smart card body is transparent or open over the verification code display unit.

16. A smart card module arrangement, comprising:
a sensor module having a fingerprint sensor; and
a verification code display unit configured to display a verification code, wherein the verification code display unit is electrically connected to the sensor module and is configured as a dynamic permanent display unit, the display of which continues to be displayed after deenergization of the verification code display unit,
wherein the sensor module is configured to control the verification code display unit to display the verification code.

17. The smart card module arrangement as claimed in claim 16,
wherein the sensor module includes a security element, and the security element is configured to control the verification code display unit to display the verification code.

18. The smart card module arrangement as claimed in claim 16,
wherein the sensor module and the verification code display unit are arranged separately from one another and are electrically conductively connected or inductively or capacitively coupled.

19. A smart card, comprising:
a smart card body; and
a smart card module arrangement as claimed in claim 16.

20. The smart card as claimed in claim 19,
wherein the smart card body is transparent or open over the verification code display unit.
